(19) United States
(12) Patent Application Publication
(10) Pub. No.: US 2013/0162483 A1
(43) Pub. Date: Jun. 27, 2013

(54) ANTENNA ASSEMBLY, METHOD OF MANUFACTURING ANTENNA ASSEMBLY AND MOBILE TERMINAL HAVING ANTENNA ASSEMBLY

(71) Applicant: Kyungsoon PARK, Seoul (KR)

(72) Inventor: Kyungsoon PARK, Seoul (KR)

(21) Appl. No.: 13/672,062

(22) Filed: Nov. 8, 2012

(30) Foreign Application Priority Data
Dec. 27, 2011 (KR) 10-2011-0143622

(51) Int. Cl. H01Q 1/38; H01P 11/00

(52) U.S. Cl. CPC H01Q 1/38; H01P 11/00
USPC 343/700 MS; 29/600

(57) ABSTRACT

An antenna assembly may include a carrier and an antenna located on the carrier to transmit a frequency in a specific RF band. The antenna may include a first pattern and a second pattern formed separately from the first pattern and coupled to the first pattern. The antenna may be configured by combining the second pattern formed separately from the first pattern with the first pattern, and thus the antenna may have various frequency bands.

### CROSS-REFERENCE TO RELATED APPLICATION

This application claims benefit and priority from Korean Patent Application 10-2011-0143622, filed Dec. 27, 2011, the subject matter of which is incorporated herein by reference.

### BACKGROUND

1. Field

Embodiments may relate to an antenna assembly, a method of manufacturing an antenna assembly and a mobile terminal including an antenna assembly. More particularly, embodiments may combine a second pattern with a first pattern to form an antenna having various frequency bands.

2. Background

As functions of terminals (such as personal computers, laptop computers, cellular phones) diversify, the terminals may be considered multimedia players having multiple functions for capturing pictures or moving images, playing music, moving image files and games and receiving broadcasting programs.

Terminals may be categorized as mobile terminals and stationary terminals. The mobile terminals may be categorized as handheld terminals and vehicle mount terminals according to whether users can personally carry the terminals. Mobile terminals may provide an increasing number of complex and various functions.

To support and enhance an increasing number of functions in a terminal, a structural part and/or a software part of the terminal may be improved.

Attempts have been made to improve antenna performance of a mobile terminal.

### BRIEF DESCRIPTION OF THE DRAWINGS

Arrangements and embodiments may be described in detail with reference to the following drawings in which like reference numerals refer to like elements and wherein:

FIG. 1 is a front perspective view of a mobile terminal according to an example embodiment of the present invention;

FIG. 2 is a rear perspective view of the mobile terminal shown in FIG. 1;

FIG. 3 is an exploded perspective view of the mobile terminal shown in FIG. 2;

FIG. 4 shows an antenna assembly of the mobile terminal shown in FIG. 3;

FIG. 5 shows a first pattern of the antenna assembly of FIG. 4;

FIG. 6 illustrates a process of providing the first pattern of FIG. 5;

FIG. 7 illustrates a process of combining a second pattern with the first pattern of FIG. 5;

FIG. 8 shows second patterns having different forms;

FIG. 9 shows examples of the second pattern; and

FIGS. 10 and 11 show antenna assemblies according to other embodiments of the present invention.

### DETAILED DESCRIPTION

Arrangements and embodiments may be described with reference to the accompanying drawings, in which exemplary embodiments may be shown. Embodiments may, however, be embodied in many different forms and should not be construed as being limited to embodiments set forth herein; rather, embodiments may be provided so that this disclosure may be thorough and complete, and may fully convey the concept to those skilled in the art.

A mobile terminal may be described with reference to the accompanying drawings. In the following description, suffixes “module” and “unit” may be provided to components of the mobile terminal in consideration of only facilitation of description and may not have meanings or functions discriminated from each other.

The mobile terminal may be a cellular phone, a smart phone, a laptop computer, a digital broadcasting terminal, personal digital assistants (PDA), a portable multimedia player (PMP), a navigation system, a tablet and/or so on.

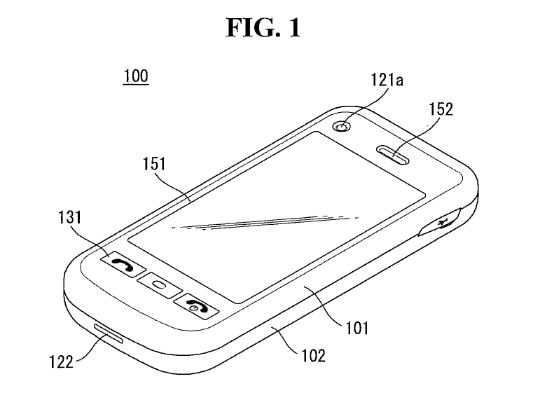

FIG. 1 is a front perspective view of a mobile terminal according to an example embodiment of the present invention. Other embodiments and configurations may also be provided.

As shown in FIG. 1, the mobile terminal 100 may have a bar-type body. The bar-type body may be formed by plastic injection or may be made of a metal such as stainless steel (STS) or titanium (Ti). However, embodiments are not limited thereto and may be applied to various structures such as slide type, folder type, swing type and swivel type structures, which may be constructed such that two or more bodies are movably combined.

A front frame 101 and a battery cover 102 of the mobile terminal 100 may be exposed to outside of the mobile terminal 100 when the mobile terminal 100 has been assembled.

The front frame 101 may be a front part of the mobile terminal 100. The front frame 101 may include a display 151 (such as a touch screen), an audio output unit 152, a front camera 121a, a user input portion 131, a microphone 122, etc.

The display 151 may be provided on a front side of the front frame 101. The display 151 may display information for operations of the mobile terminal 100. The display 151 may display 2D image and/or perceived 3D images.

The audio output unit 152 may be a speaker that outputs a tone. The mobile terminal 100 may include a plurality of audio output units 152. For example, the mobile terminal 100 may have a plurality of audio output units 152 for outputting a tone or a bell sound.

The front camera 121a may be provided such that a user of the mobile terminal 100 may be photographed by the front camera 121a. For example, the user may perform a video call with another user based on an image of the user, captured by the front camera 121a.

The user input portion 131 may be provided to receive commands for controlling operations of the mobile terminal 100, and the user input portion 131 may include a plurality of manipulating units. The user input portion 131 may sense a user input in a static manner, and the user input portion 131 may generate light upon a user input applied thereto.

The user input portion 131 may be called a manipulating portion and may operate in a tactile manner. For example, the user input portion 131 may be a physical button.

The user input portion 131 may be assigned functions that are frequently used or are important. For example, a start, an end, an audio adjustment function of the mobile terminal 100 and/or an application may be allocated to the user input portion 131.

The microphone 122 may acquire a user voice, etc. The microphone 122 may be provided at a bottom of the body of the mobile terminal 100.

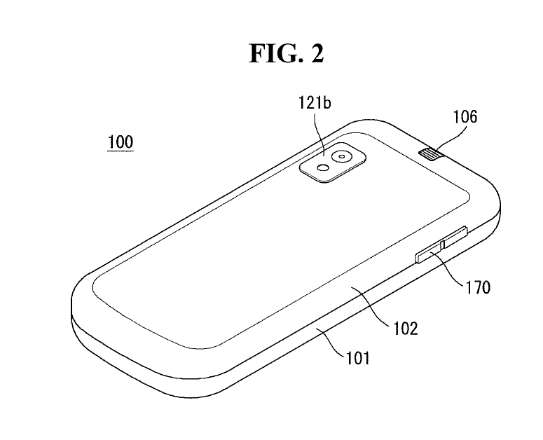

FIG. 2 is a rear perspective view of the mobile terminal shown in FIG. 1.

Referring to FIG. 2, a battery cover 102 may be exposed from a backside of the body of the mobile terminal 100. A rear camera 121b and a side key button 170 may be provided at the battery cover 102.

The rear camera 121b may be provided to the backside of the mobile terminal 100. The rear camera 121b may capture 3D images. For example, the rear camera 121b can capture left-eye and right-eye images.

A camera flash may be positioned in proximity to the rear camera 121b. The camera flash 123 may operate when an image is captured.

The side key button 170 may be provided to a side of the body of the mobile terminal 100 and may include a volume control switch. A volume of the mobile terminal 100 may be controlled by pushing an upper part or a lower part of the volume control switch 170.

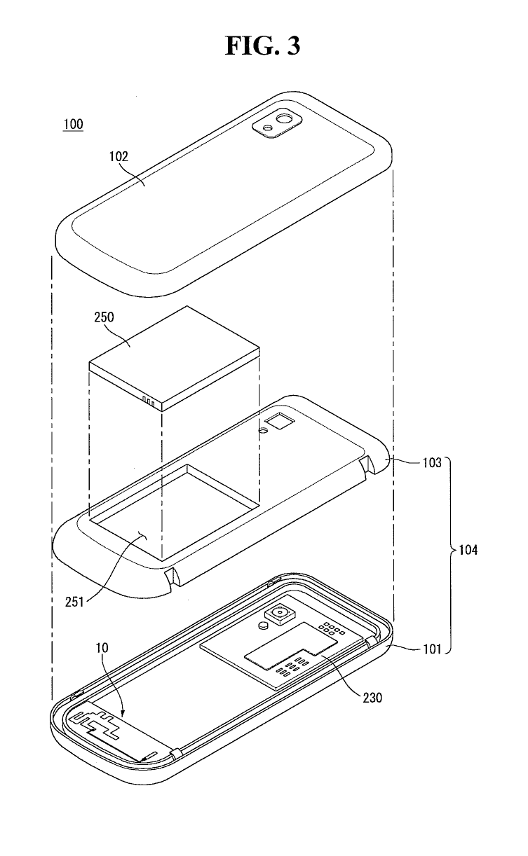

FIG. 3 is an exploded perspective view of the mobile terminal 100 shown in FIG. 2.

Referring to FIG. 3, the mobile terminal 100 may include a body 104 consisting of a rear body 103 and a front body 101, the battery cover 102 combined with the rear body 103, and an antenna assembly 10.

The battery cover 102 may shield a battery 250 fitted in the body 104 of the mobile terminal 100 in a changeable manner to make a clean appearance of the mobile terminal 100. The battery cover 102 may be a pull type such that the battery cover 102 may be pulled from the backside of the mobile terminal 100 to separate from the body 104 of the mobile terminal 100. The battery cover 102 may be a sliding type such that the battery cover 102 may slide in a longitudinal direction of the mobile terminal 100 to separate from the body 104 of the mobile terminal 100. The battery cover 102 may also be a pop-up type to separate the battery cover 102 from the body 104 by pushing a button.

The body 104 may be formed by combining the rear body 103 and the front body 101. The rear body 103 may have a battery combining hole 251 through which the battery 250 is fitted into the body 104. The battery 250 may be received within the battery combining hole 251.

The front body 101 may have a shape corresponding to the rear body 103. The front body 101 may include a printed circuit board (PCB) 230 that is mounted on the front body 101.

The PCB 230 may include electronic components and electronic circuits necessary for operations of the mobile terminal 100. The mobile terminal 100 may include a plurality of PCBs.

The antenna assembly 10 may be provided at a predetermined position of the mobile terminal 100. For example, the antenna assembly 10 may be provided in a space formed by a combination of the front body 101 and the rear body 103. At least one component of the antenna assembly 10 may be exposed to outside of the mobile terminal 100.

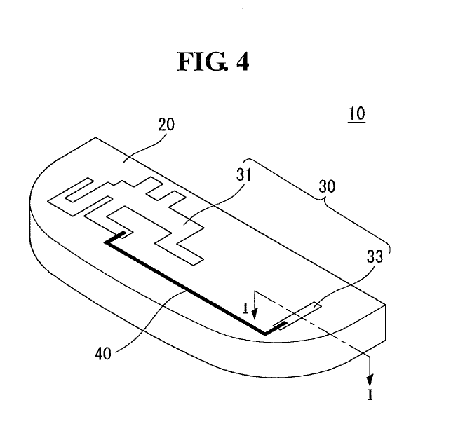

FIG. 4 shows the antenna assembly 10 of FIG. 3.

As shown in FIG. 4, the antenna assembly 10 may include a carrier 20 and an antenna mounted on the carrier 20. The antenna may include a first pattern 30 and a second pattern 40.

The carrier 20 may be a body of the antenna assembly 10. That is, components of the antenna assembly 10 may be attached to the carrier 20. The carrier 20 may be made of a plastic material such as polycarbonate (PC). The carrier 20 may be formed of a plastic material having a specific volume. For example, the carrier 20 may have a hexahedral shape. An inside of the hexahedral carrier 20 may be vacant, and thus the carrier 20 may be light for the volume thereof. An antenna pattern may be formed in a vacant internal space of the carrier 20.

The antenna (i.e., the first pattern 30 and the second pattern 40) may be mounted on the carrier 20. A plurality of antennas corresponding to different radio frequency (RF) bands may be provided. The antennas may be positioned on a plurality of faces, such as an outer face, an inner face, a top face, a side face and/or a bottom face of the carrier 20. The antenna corresponding to one RF band may be located over the plurality of faces. The antenna may include the first pattern 30 and the second pattern 40, and may operate in a specific RF band. That is, the first pattern 30 and the second pattern 40 may form one pattern and may operate in the specific RF band.

The first pattern 30 may be formed on the carrier 20. The first pattern 30 may be formed such that part of the carrier 20 made of plastics may be selectively etched. The first pattern 30 formed on the carrier 20 may include a plurality of parts. For example, the first pattern 30 may be separated into a first region 31 and a second region 33. The first and second regions 31 and 33 may be separated from each other and may be respectively positioned at one side and the other side of the carrier 20.

The second pattern 40 may be formed separately from the first pattern 30, and the second pattern may be combined with (or coupled to) the first pattern 30. The antenna operating in the specific RF band may be configured by combining the separately formed second pattern 40 with the first pattern 30. That is, a pattern having a specific length corresponding to the specific RF band may be necessary for the antenna (i.e., the first pattern 30 and the second pattern 40) to operate in the specific RF band, and the first and second patterns 30 and 40 may provide the pattern having the specific length.

A frequency corresponding to the specific RF band may depend on specifications of the mobile terminal 100. For example, a frequency band for CDMA communication may be different from a frequency band for LTE communication. Thus, an antenna for CDMA and an antenna for LTE may have different patterns. Further, the frequency band of the LTE antenna may depend on a service provider that provides the corresponding RF service. For example, if service provider A uses a frequency band from a to b and service provider B uses a frequency band from b to c, then the antenna patterns may be differently determined according to the respective service providers.

To provide the mobile terminal 100 using a frequency corresponding to a specific band, the antenna having a pattern for each service provider may be included in the mobile terminal 100, as described above. Accordingly, the antenna may be tuned to each service provider and/or each frequency. In the mobile terminal 100, tuning may be effectively performed by forming the second pattern 40 separately from the first pattern 30. That is, the antenna may be configured such that the first pattern 30 having a fixed shape or length is formed on the carrier 20 and the second patterns 40 having different shapes or lengths may be selectively combined with (or coupled to) the first pattern 30. Accordingly, it may be possible to effectively produce the antenna assembly 10 that may allow the carrier 20 to be changed depending on service provider and/or frequency.

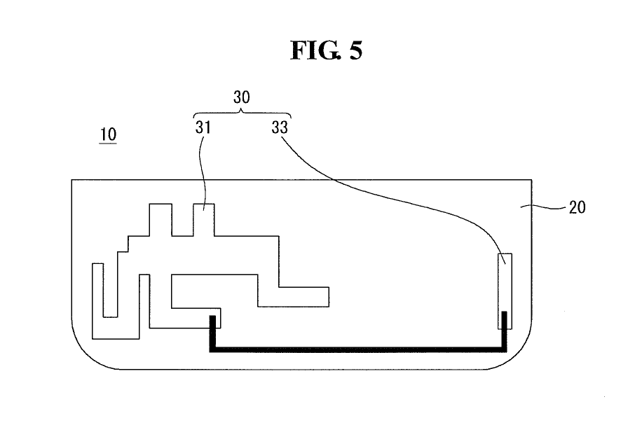

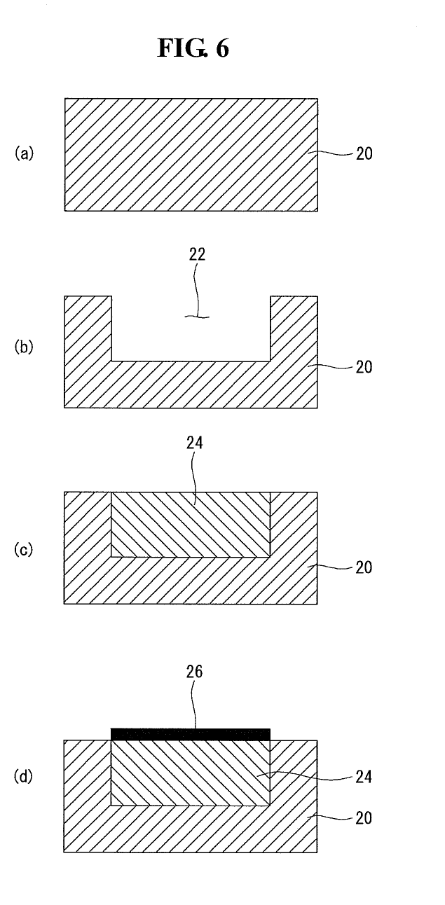

FIG. 5 shows the first pattern 30 of the antenna assembly 10 of FIG. 4. FIG. 6 illustrates a process of providing the first pattern 30.

Referring to FIG. 5, the antenna assembly 10 may include the first pattern 30 formed on the carrier 20. The first pattern 30 may include the first region 31 and the second region 33 that is separated from the first region 31.

FIG. 6 is a cross-sectional view taken along line I-I of FIG. 4, which shows a process of providing the first pattern 30.

Referring to FIG. 6(a), the carrier 20 may be provided.

Referring to FIG. 6(b), a recess 22 may be formed on a top face of the carrier 20. The recess 22 may be formed by processing one side of the carrier 20. For example, the recess 22 may be formed by etching a predetermined portion of the carrier 20 or by processing the portion using a tool.

Referring to FIG. 6(c), a filler 24 (such as ABS resin) may be provided (or stuffed) in the recess 22. The filler 24 may be a material that satisfies a designed dielectric constant and/or transmissivity. Performance of the antenna may be tuned by appropriately selecting the filler 24.

Referring to FIG. 6(d), a plating 26 may be attached to a top of the filler 24. The plating 26 may be made of copper (Cu), nickel (Ni) and/or the like. The plating 26 may protect the filler 24.

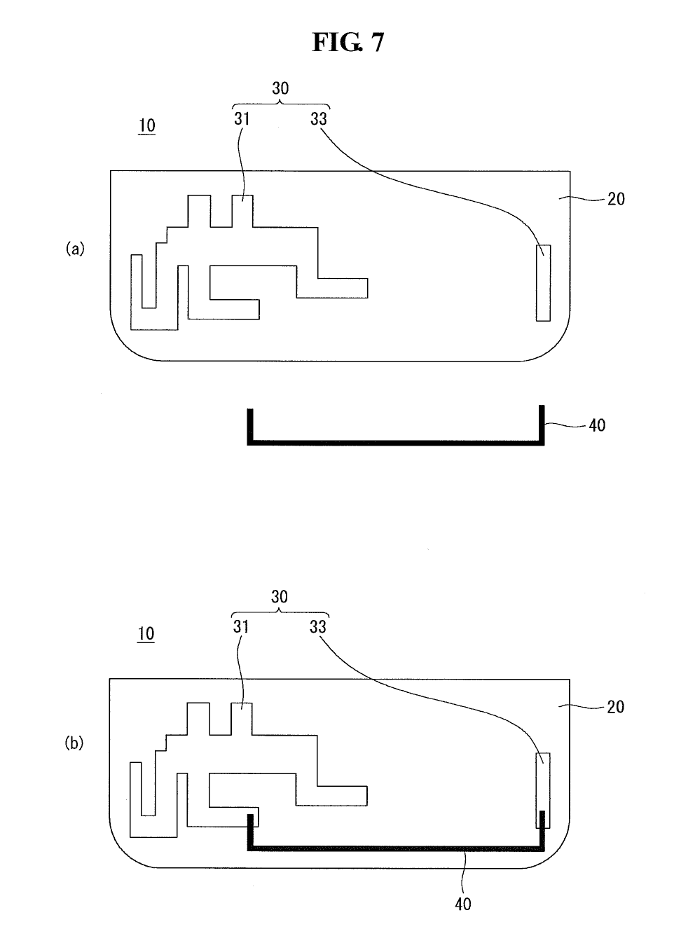

FIG. 7 shows a process of combining (or coupling) the second pattern 40 with the first pattern 30.

As shown in FIG. 7, the antenna assembly 10 (of the mobile terminal 100) may be formed by a method of separately forming the first pattern 30 and the second pattern 40 and connecting the first and second patterns 30 and 40.

Referring to FIG. 7(a), the first pattern 30 may be formed on the carrier 20. The second pattern 40 may be formed through a separate process.

Referring to FIG. 7(b), the second pattern 40 may be combined with or coupled to the first pattern 30. The first and second patterns 30 and 40 may be connected to each other through a bonding process using an adhesive, a soldering process using a solder, etc.

The second pattern 40 may be connected with the first pattern 30 after providing (or stuffing) the filler 24 (FIG. 6). That is, the second pattern 40 may be connected with the first pattern 30 before the filler 24 (FIG. 6) provided in the recess 22 (FIG. 6) is shielded by the plating 26 (FIG. 6). Otherwise, the second pattern 40 may be combined with the first pattern 30 after the plating 26 (FIG. 6) is formed on the filler 24 (FIG. 6).

Upon connection (or coupling) of the first and second patterns 30 and 40, radio waves corresponding to a frequency band based on a length of the first and second patterns 30 and 40 may be transmitted and received. Since the second pattern 40 is formed separately from the first pattern 30 and connected with the first pattern 30, tuning of the antenna may be easily performed. Accordingly, it may be unnecessary to separately produce antenna assemblies for respective service providers.

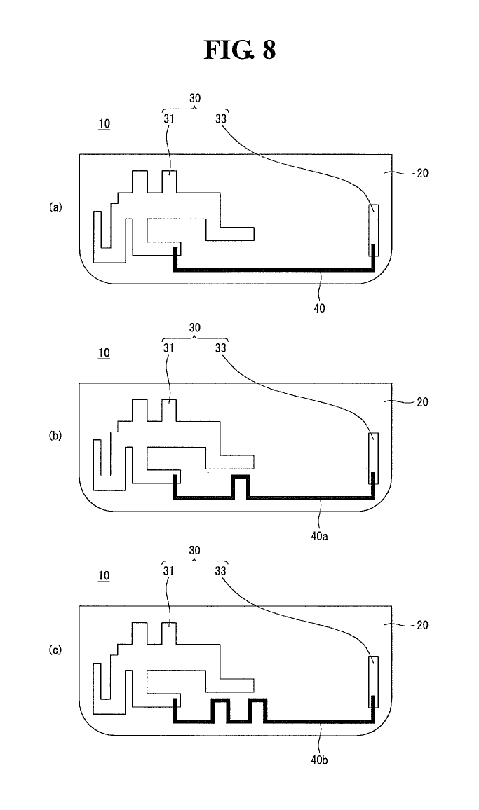

FIG. 8 shows second patterns having different forms.

As shown in FIG. 8, the second pattern 40 may be appropriately tuned to output a frequency in a designated band.

Referring to FIG. 8(a), the second pattern 40 may be a linear pattern that connects the first and second regions 31 and 33 of the first pattern 30. For example, the antenna formed of the first and second patterns 30 and 40 may be an antenna for LTE, and the antenna having the linear second pattern 40, shown in FIG. 8(a), may be an antenna for service provider A.

Referring to FIG. 8(b), a second pattern 40a may have a length greater than the second pattern 40 shown in FIG. 8(a), and thus the first and second regions 31 and 33 of the first pattern 30 can be connected to each other through the longer second pattern 40a. When the length of the second pattern 40a is varied, the frequency output from the antenna formed of the first and second patterns 30 and 40a may change from the frequency output from the antenna shown in FIG. 8(a). Accordingly, the antenna to which the second pattern 40a (shown in FIG. 8(b)), is applied may be an antenna for service provider B.

Referring to FIG. 8(c), a second pattern 40b may have a length greater than the second patterns 40 and 40a shown in FIGS. 8(a) and 8(b), respectively. When the longer second pattern 40b is applied, the frequency output from the antenna formed of the first and second patterns 30 and 40b may be different from that output from the antennas shown in FIGS. 8(a) and 8(b).

As shown in FIG. 8, the antenna assembly 10 can output different frequencies by combining (or coupling) the second patterns 40, 40a and 40b having different paths and/or lengths with the first pattern 30 without changing other elements. Accordingly, an antenna tuning may be facilitated to easily provide the mobile terminal 100 for different service providers.

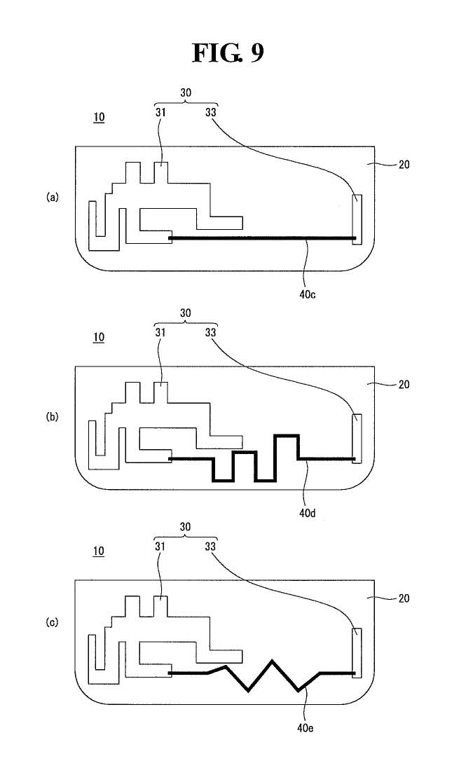

FIG. 9 shows examples of the second pattern.

Referring to FIG. 9(a), a second pattern 40c may have a line (or linear) shape. That is, the first and second regions 31 and 33 of the first pattern 30 may be connected to each other by the second pattern 40c in the line form.

Referring to FIG. 9(b), a second pattern 40d may have a meandering shape. That is, the first and second regions 31 and 33 of the first pattern 30 may be connected to each other by the second pattern 40d having a plurality of bent portions.

Referring to FIG. 9(c), a second pattern 40e may have a saw shape. That is, the first and second regions 31 and 33 of the first pattern 30 may be connected to each other by the second pattern 40e having a saw shape.

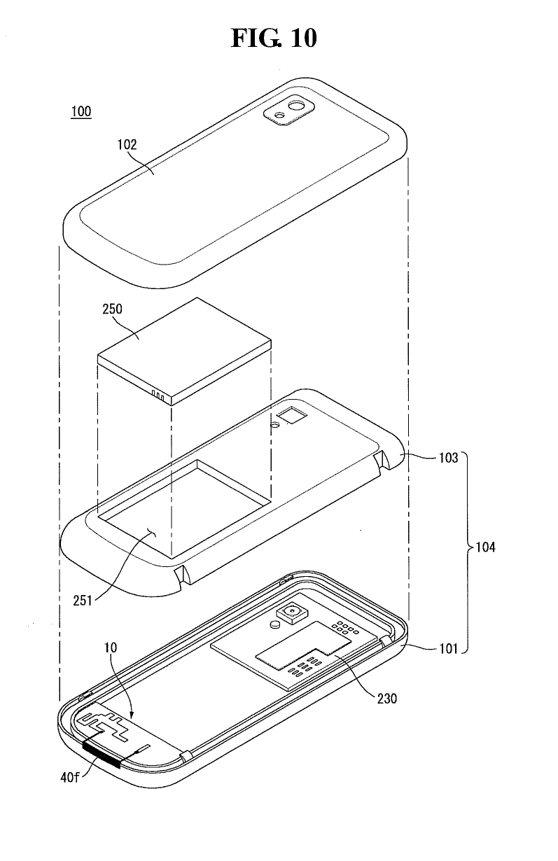

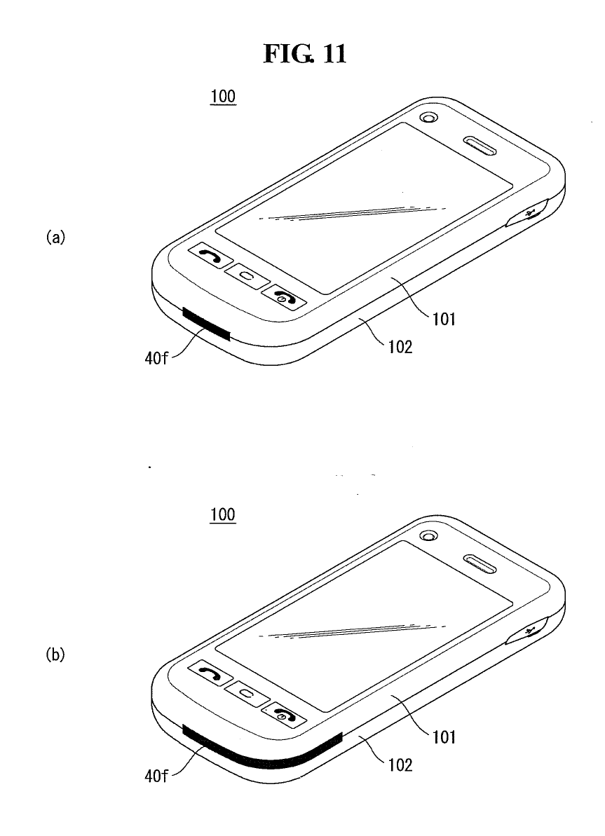

FIGS. 10 and 11 show antenna assemblies according to other embodiments of the present invention. Other embodiments and configurations may also be provided.

As shown in FIGS. 10 and 11, in the mobile terminal 100, at least part of the antenna may be exposed to outside of the body 104 of the mobile terminal 100.

Referring to FIG. 10, a second pattern 40f of the antenna assembly 10 may be exposed to outside of the body 104 (of the mobile terminal 100). For example, part of the second pattern 40f combined with the antenna assembly 10 may be exposed to a side of the body 104 (of the mobile terminal 100).

When the second pattern 40f is exposed, improvement of antenna performance may be expected. That is, a frequency can be directly transmitted and received without passing through the body 104 that may obstruct transmission and reception of the frequency, to thereby improve antenna performance.

When the second pattern 40f is exposed, an internal space of the mobile terminal 100 may be used more effectively. That is, a space necessary to form the second pattern 40f may be used for other elements of the mobile terminal 100. Further, an internal volume of the body 104 (of the mobile terminal 100) may be reduced by exposing the second pattern 40f to the outside of the body 104. Accordingly, a size of the mobile terminal 100 may decrease.

Referring to FIG. 11, the second pattern 40f exposed to outside of the body 104 may be formed in different shapes.

Since the second pattern 40f is exposed to the outside of the mobile terminal 100, antenna performance may be improved and volume of the mobile terminal 100 may be reduced, as described above. In addition, the second pattern 40f may be used to discriminate the mobile terminal 100. That is, length, area and color of the second pattern 40f can be changed for mobile terminals such that a user can have a unique mobile terminal of his own.

Referring to FIG. 11(a), the second pattern 40f may be positioned at one side of the outside of the mobile terminal 100. For example, the second pattern 40f having a predetermined length may be located at a bottom side of the mobile terminal 100.

Referring to FIG. 11(b), the second pattern 40f may be positioned on a plurality of faces of the mobile terminal 100. For example, the second pattern 40f may be located at the bottom face of the mobile terminal 100 and may extend to an adjacent side of the mobile terminal 100.

As shown in FIGS. 11(a) and 11(b), a degree by which the second pattern 40f for transmitting or receiving a specific frequency is exposed may change to vary the frequency band of the antenna and to represent a specific service provider by means of the second pattern 40f.

The above-described method of controlling the mobile terminal may be written as computer programs and may be implemented in digital microprocessors that execute the programs using a computer readable recording medium. The method of controlling the mobile terminal may be executed through software. The software may include code segments that perform required tasks. Programs or code segments may also be stored in a processor readable medium or may be transmitted according to a computer data signal combined with a carrier through a transmission medium or communication network.

The computer readable recording medium may be any data storage device that can store data that can be thereafter read by a computer system. Examples of the computer readable recording medium may include read-only memory (ROM), random-access memory (RAM), CD-ROMs, DVD±ROM, DVD-RAM, magnetic tapes, floppy disks, optical data storage devices. The computer readable recording medium may also be distributed over network coupled computer systems so that the computer readable code is stored and executed in a distribution fashion.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An antenna assembly comprising:
a carrier; and
an antenna located at the carrier to transmit a frequency in a specific radio frequency (RF) band,
wherein the antenna includes a first pattern and a second pattern coupled to the first pattern, the second pattern being formed separately from the first pattern, and the frequency of the specific RF band is based on a characteristic of at least one of the first pattern and the second pattern.

2. The antenna assembly of claim 1, wherein the second pattern is coupled to at least part of the first pattern, and the frequency in the specific RF band is determined by at least one of a length, an area and a shape of at least one of the first pattern and the second pattern.

3. The antenna assembly of claim 1, wherein the first pattern is formed of a conductive material, and the first pattern is formed to have a predetermined length on at least part of the carrier.

4. The antenna assembly of claim 1, wherein the frequency in the specific RF band is determined based at least one of a length, an area and a shape of the second pattern.

5. The antenna assembly of claim 1, wherein the second pattern is at least one of a line pattern, a meander pattern or a saw pattern coupled to at least part of the first pattern.

6. The antenna assembly of claim 1, wherein the second pattern extends to outside of the carrier.

7. A mobile terminal comprising:
a body; and
an antenna assembly located at one side of the body,
wherein the antenna assembly includes a carrier and an antenna at the carrier to transmit a frequency in a specific radio frequency (RF) band,
wherein the antenna includes a first pattern and a second pattern that is electrically coupled to the first pattern, the second pattern being formed separately from the first pattern, and the frequency in the specific RF band is based on a characteristic of at least one of the first pattern and the second pattern.

8. The mobile terminal of claim 7, wherein the second pattern is coupled to at least part of the first pattern, and the frequency in the specific RF band is determined by at least one of a length, an area and a shape of at least one of the first pattern and the second pattern.

9. The mobile terminal of claim 7, wherein at least an exposed part of the second pattern is exposed to one side of the body.

10. The mobile terminal of claim 9, wherein the one side of the body corresponds to at least one side surface of the body.

11. The mobile terminal of claim 9, wherein the frequency in the specific RF band is determined based on at least one of a length, an area and a shape of the at least exposed part of the second pattern.

12. The mobile terminal of claim 7, wherein the second pattern is at least one of a line pattern, a meander pattern or a saw pattern coupled to at least part of the first pattern.

13. The mobile terminal of claim 7, wherein the second pattern extends to outside of the carrier.

14. A method of manufacturing an antenna assembly, comprising:
providing a carrier;
forming a first pattern on the carrier; and
separately forming a second pattern on the carrier, the second pattern to couple to the performed first pattern, wherein the second pattern is formed to a frequency in a specific RF band based on a characteristic of the second pattern.

15. The method of claim 14, wherein forming the first pattern includes:
filling a dielectric material in a slit formed at the carrier, and
forming the second pattern is performed after filling the dielectric material.

16. The method of claim 14, wherein forming the first pattern includes:
filling a dielectric material in a slit formed at the carrier; and
forming a plate for protecting the filled dielectric material,
wherein separately forming the second pattern is performed after forming the plate.

17. The method of claim 14, wherein the second pattern is coupled to at least part of the first pattern, and the frequency in the specific RF band is determined by at least one of a length, an area and a shape of the second pattern.

18. The method of claim 14, wherein the first pattern is formed of a conductive material, and the first pattern is formed to have a predetermined length on at least part of the carrier.

19. The method of claim 14, wherein the second pattern is at least one of a line pattern, a meander pattern or a saw pattern coupled to at least part of the first pattern.

20. The method of claim 14, wherein the second pattern extends to outside of the carrier.
